(19) United States
(12) Patent Application Publication
(10) Pub. No.: US 2017/0090778 A1
(43) Pub. Date: Mar. 30, 2017

(54) STORAGE APPARATUS AND CONTROL DEVICE

(71) Applicant: FUJITSU LIMITED, Kawasaki-shi (JP)

(72) Inventor: Hajime Ishiguro, Kawasaki (JP)

(21) Appl. No.: 15/244,852

(22) Filed: Aug. 23, 2016

(30) Foreign Application Priority Data
Sep. 25, 2015 (JP) 2015-188385

(51) Int. Cl. G06F 3/06

(52) U.S. Cl. CPC G06F 3/0611; G06F 3/065; G06F 3/0683

(57) ABSTRACT

A storage apparatus includes a first storage device to store data, a second storage device to store data identical to the data stored in the first storage device, a memory device to store a first threshold value which is set on basis of response times for accessing first plural sections of the first storage device, and a processor. The processor is configured to measure a first response time for reading data from the respective first plural sections. The processor is configured to read first data from the second storage device when a first target section of the first plural sections is detected. The first response time for reading data from the first target section is greater than the first threshold value. The first data is identical to data stored in the first target section. The processor is configured to write the first data to the first target section.

### CROSS-REFERENCE TO RELATED APPLICATION

This application is based upon and claims the benefit of priority from the prior Japanese Patent Application No. 2015-188385 filed on Sep. 25, 2015, the entire contents of which are incorporated herein by reference.

### FIELD

The embodiments discussed herein are related to a storage apparatus and a control device.

### BACKGROUND

A hard disk drive (HDD) has been widely used as a storage device for storing data used in a computer. In an effort to prevent data loss or business stop due to, for example, a malfunction of an HDD, a redundant array of inexpensive disks (RAID) device has also been spread in which plural HDDs are coupled with each other to achieve a redundancy. As a RAID system, there are systems such as RAID1 (mirroring) in which identical data is stored in plural HDDs and RAID0 (striping) in which data is distributed and stored in plural HDDs.

In the case of the mirroring system, identical data is stored in at least two HDDs. Accordingly, even when an HDD malfunctions, the data remains in an HDD which normally operates. As a result, it is possible to expect an effect that the data loss or business stop due to the malfunction of the HDD may be prevented.

For example, when one of HDDs malfunctions, the redundancy is secured again so as to enable business to safely continue by replacing the malfunctioning HDD with a spare HDD and copying data of the normally operating HDD to the replaced HDD. In addition, by responding to a host computer after verifying that the data read from the plural HDDs are equivalent with each other, it is possible to reduce a risk of returning incorrect data thereby enhancing reliability.

In a system employing the mirroring system, a technique has been proposed in which an abnormal area of one HDD from which data reading fails is replaced with a storage area of a different HDD and data read from the other HDD is copied to the replaced storage area. In addition, a technique has been proposed in which data read from the other HDD is re-written to a storage area of an HDD from which a read error is detected thereby suppressing adjacent track interference (ATI). The ATI refers to a phenomenon in which magnetic field leakage occurs between adjacent tracks.

Related techniques are disclosed in, for example, Japanese Laid-Open Patent Publication No. 2013-130995 and Japanese Laid-Open Patent Publication No. 04-157676.

A written state of data may degrade due to the ATI or the like. When the written state of data degrades, the data may not be read by one-time access. When data reading is failed, the HDD re-attempts (read-retry) to access the sector to which the data is written to read the data. The data may be read by repeating the read-retry multiple times, but when the data is not read even by performing the read-retry by a predetermined number of times, this situation becomes a read error.

In the above-mentioned related techniques, when a read error occurs, the read error due to the ATI is coped with by performing rewriting of data and restoring the written state. However, when the written state degrades to such an extent that a read error is not caused, data may still be read, but the read-retry is frequently performed. In this state, in a system that verifies equivalence of data read from plural HDDs to respond to a host computer, a response time extends by a time amount to wait for the reading from the HDD of which the written state is degraded.

### SUMMARY

According to an aspect of the present invention, provided is a storage apparatus including a first storage device, a second storage device, a memory device, and a processor. The first storage device is configured to store therein data. The second storage device is different from the first storage device. The second storage device is configured to store therein data identical to the data stored in the first storage device. The memory device is configured to store therein a first threshold value which is set on basis of response times for accessing first plural sections of the first storage device. The processor is configured to measure a first response time for reading data from the respective first plural sections. The processor is configured to read first data from the second storage device when a first target section of the first plural sections is detected. The first response time for reading data from the first target section is greater than the first threshold value. The first data is identical to data stored in the first target section. The processor is configured to write the first data to the first target section.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a storage apparatus according to a first embodiment;

FIG. 2 is a diagram illustrating an example of a storage apparatus according to a second embodiment;

FIG. 3 is a diagram illustrating an example of functions of a RAID controller according to the second embodiment;

FIG. 4 is a diagram illustrating an example of a management table according to the second embodiment;

FIG. 5 is a diagram illustrating an example of state information according to the second embodiment;

FIG. 6 is a diagram illustrating an example of command information;

FIG. 7 is a flowchart illustrating a flow of a start-up process which is performed by the RAID controller according to the second embodiment;

FIG. 8 is a flowchart illustrating a flow of a management table preparation process which is performed by the RAID controller according to the second embodiment;

FIG. 9 is a first flowchart illustrating a flow of an idle process which is performed by the RAID controller according to the second embodiment;

FIG. 10 is a second flowchart illustrating a flow of the idle process which is performed by the RAID controller according to the second embodiment;

FIG. 11 is a flowchart illustrating a flow of a state information update process which is performed by the RAID controller according to the second embodiment;

FIG. 12 is a first flowchart illustrating a flow of a patrol verification process which is performed by the RAID controller according to the second embodiment;

FIG. 13 is a second flowchart illustrating a flow of the patrol verification process which is performed by the RAID controller according to the second embodiment; and

FIG. 14 is a third flowchart illustrating a flow of the patrol verification process which is performed by the RAID controller according to the second embodiment.

### DESCRIPTION OF EMBODIMENTS

Hereinafter, embodiments of the present disclosure will be described with reference to the accompanying drawings. In the specification and the drawings, elements having substantially same functions may be referenced by the same reference numerals and description thereof may not be repeated.

### First Embodiment

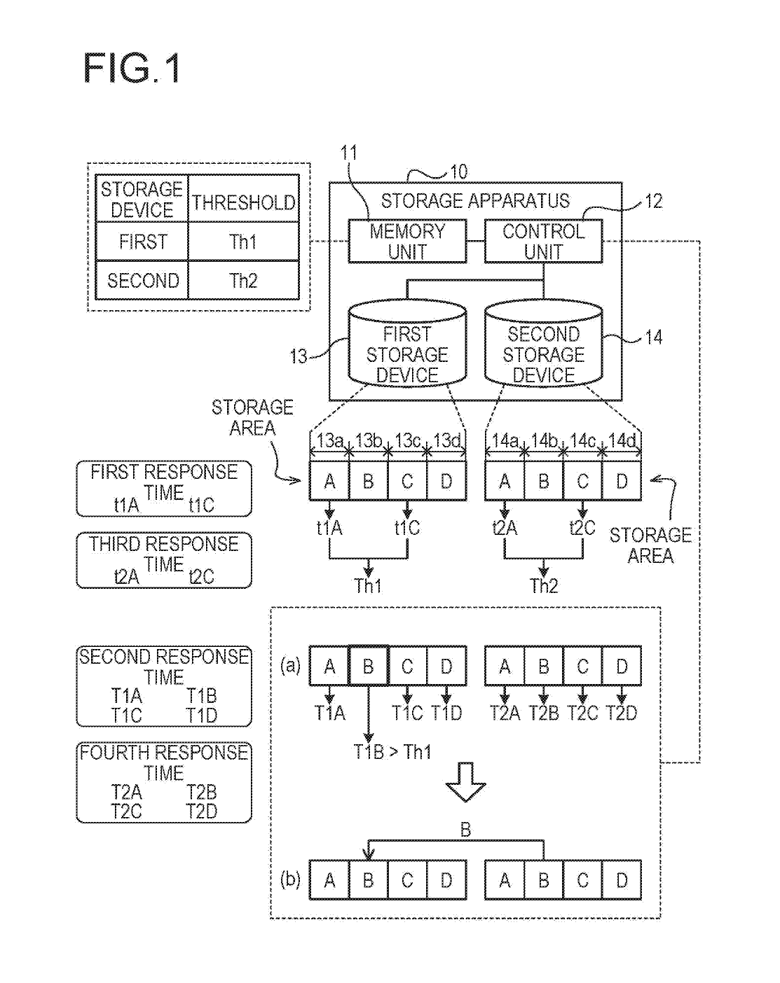

A first embodiment will be described below with reference to FIG. 1.

The first embodiment relates to a storage apparatus that writes identical data into plural storage devices and provides a method of measuring a response time for a read access to each section of a storage area, which is a unit of data access, and rewriting data of another storage device to a section having a relatively long response time. When the method according to the first embodiment is applied, the written state of data is maintained well and it is thus possible to suppress the number of times of the read-retry caused by the degradation of the written state, thereby speeding up the read access.

FIG. 1 is a diagram illustrating an example of a storage apparatus according to the first embodiment. The storage apparatus 10 illustrated in FIG. 1 is an example of a storage apparatus according to the first embodiment.

As illustrated in FIG. 1, the storage apparatus 10 includes a memory unit 11, a control unit 12, a first storage device 13, and a second storage device 14. For the purpose of convenience of explanation, the storage apparatus 10 including two storage devices is exemplified, but the number of storage devices may be three or more.

The memory unit 11 is, for example, a volatile memory such as a random access memory (RAM), a nonvolatile memory such as an electrically erasable programmable read-only memory (EEPROM) or a flash memory, an HDD, or the like. The control unit 12 is a processor such as a central processing unit (CPU) or a digital signal processor (DSP). The control unit 12 executes, for example, a program stored in the memory unit 11 or another memory.

The first storage device 13 and the second storage device 14 are magnetic disk devices such as HDDs. The first storage device 13 and the second storage device 14 store therein identical data by the mirroring.

In the example illustrated in FIG. 1, data A, B, C, and D are stored in sections 13a, 13b, 13c, and 13d of a storage area of the first storage device 13, respectively. Similarly, data A, B, C, and D are stored in sections 14a, 14b, 14c, and 14d of a storage area of the second storage device 14, respectively. Each of the sections 13a, 13b, 13c, 13d, 14a, 14b, 14c, and 14d is a sector which is a unit of data access.

A first threshold value Th1 is stored in the memory unit 11. The first threshold value Th1 is set on the basis of the first response times t1A and t1C of the accesses to the sections 13a and 13c of the first storage device 13, respectively. In the example of FIG. 1, the first response times t1A and t1C are used to set the first threshold value Th1, but the response times measured for the sections 13b and 13d may be used to set the first threshold value Th1.

In the example of FIG. 1, a second threshold value Th2 is stored in the memory unit 11. The second threshold value Th2 is set on the basis of the third response times t2A and t2C of the accesses to sections 14a and 14c of the second storage device 14, respectively. In the example of FIG. 1, the third response times t2A and t2C are used to set the second threshold value Th2, but the response times measured for the sections 14b and 14d may be used to set the second threshold value Th2.

The control unit 12 measures the second response times T1A, T1B, T1C, and T1D which are required for data reading for error detection in the respective sections of the first storage device 13. When a section in which the second response time is greater than the first threshold value Th1 is detected, the control unit 12 reads data, which is identical to the data of the section, from the second storage device 14 and writes the read data to the section.

In the example illustrated in FIG. 1, the second response time T1B is greater than the first threshold value Th1. In this case, the control unit 12 reads the data B, which is identical to the data B of the section 13b, from the section 14b of the second storage device 14 and writes the read data B to the section 13b. The fourth response times T2A, T2B, T2C, and T2D are compared with the second threshold value Th2.

In this way, by detecting a section, in which the written state of data degrades, on the basis of the response times and restoring the written state by rewriting, it is possible to keep the written states of the sections in an excellent condition. As a result, it is possible to suppress the number of times of the read-retry due to the degradation of the written state thereby speeding up a response to a read access.

Hitherto, the first embodiment has been described.

### Second Embodiment

A second embodiment will be described below.

The second embodiment relates to a storage apparatus that writes identical data into plural HDDs and provides a method of measuring response times of read accesses to sections of each HDD and rewriting data of another HDD to a section having a relatively long response time to keep the written state in an excellent condition. When the method according to the second embodiment is applied, the written state of data may be kept in an excellent condition and it is thus possible to suppress the number of times of the read-retry due to degradation of the written state and to speed up a read access.

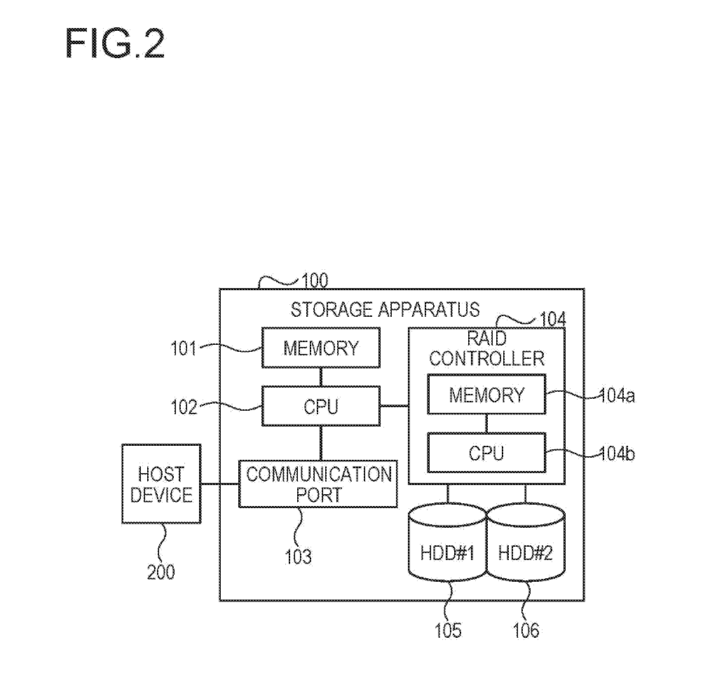

A storage apparatus 100 will be described below with reference to FIG. 2. FIG. 2 is a diagram illustrating an example of a storage apparatus according to the second embodiment. The storage apparatus 100 illustrated in FIG. 2 is an example of a storage apparatus according to the second embodiment.

The storage apparatus 100 includes a memory 101, a CPU 102, a communication port 103, a RAID controller 104, and HDDs 105 and 106. In the following description, for the purpose of convenience of explanation, the HDD 105 may be referred to as HDD#1. Similarly, the HDD 106 may be referred to as HDD#2.

The memory 101 is a volatile memory such as a RAM or a nonvolatile storage device such as an HDD, a solid state drive (SSD), or a flash memory. The CPU 102 controls the operation of the storage apparatus 100. The communication port 103 is an interface for communication with a host device 200 through a communication line such as a local area network (LAN) or a Fibre Channel (FC). The host device 200 is a computer such as a server device in which a business application or the like operates.

The RAID controller 104 performs control of a read access and a write access to the HDDs 105 and 106 and performs a control process for implementing a redundancy using the RAID. The RAID controller 104 includes a memory 104a and a CPU 104b. The memory 104a is a nonvolatile memory such as an EEPROM. The CPU 104b performs access control to the HDDs 105 and 106.

The CPU 104b performs a process of verifying written states of data which are written to sectors of the HDDs 105 and 106 and restoring the written state of a sector having been degraded, or the like. The HDDs 105 and 106 are coupled with the RAID controller 104, for example, in a small computer system interface (SCSI) manner or a serial advanced technology attachment (SATA) manner. The HDDs 105 and 106 are operated in the RAID1 (mirroring).

In the following description, an HDD with SATA connection will be exemplified for the purpose of convenience of explanation, but when an HDD with SCSI connection is used, SCSI commands are used instead of ATA commands.

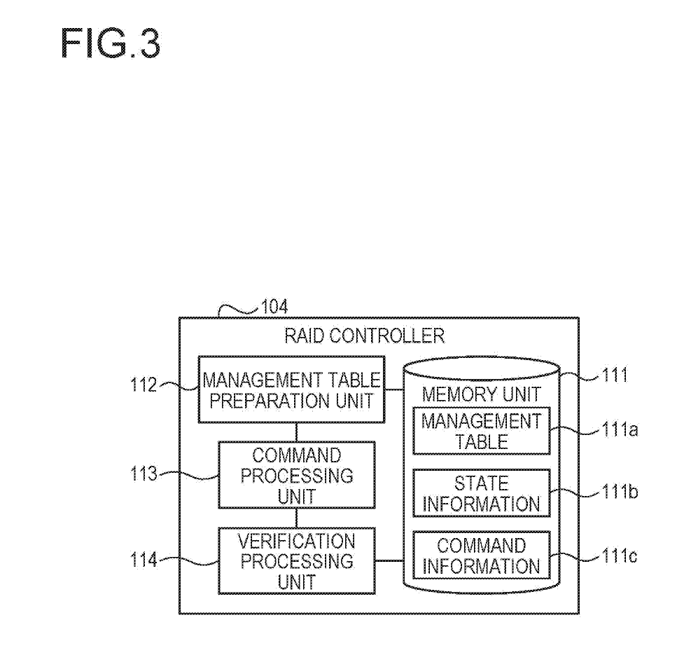

The functions of the RAID controller 104 will be described below with reference to FIG. 3. FIG. 3 is a diagram illustrating an example of functions of the RAID controller according to the second embodiment.

As illustrated in FIG. 3, the RAID controller 104 includes a memory unit 111, a management table preparation unit 112, a command processing unit 113, and a verification processing unit 114.

The function of the memory unit 111 may be implemented using the above-mentioned memory 104a. The functions of the management table preparation unit 112, the command processing unit 113, and the verification processing unit 114 may be implemented using the above-mentioned CPU 104b.

A management table 111a, state information 111b, and command information 111c are stored in the memory unit 111.

The management table 111a is a table in which information for managing the HDDs 105 and 106 is stored. The management table 111a includes information which is used to determine the written state of each sector of the HDDs 105 and 106. The state information 111b is information indicating a progress state of a verification process (a process of verifying whether data is normally read from a sector) for each sector of the HDDs 105 and 106. The command information 111c is a code table in which codes for identifying a type of a command are collected. The command information 111c is used to determine a type of a command which is received from the host device 200.

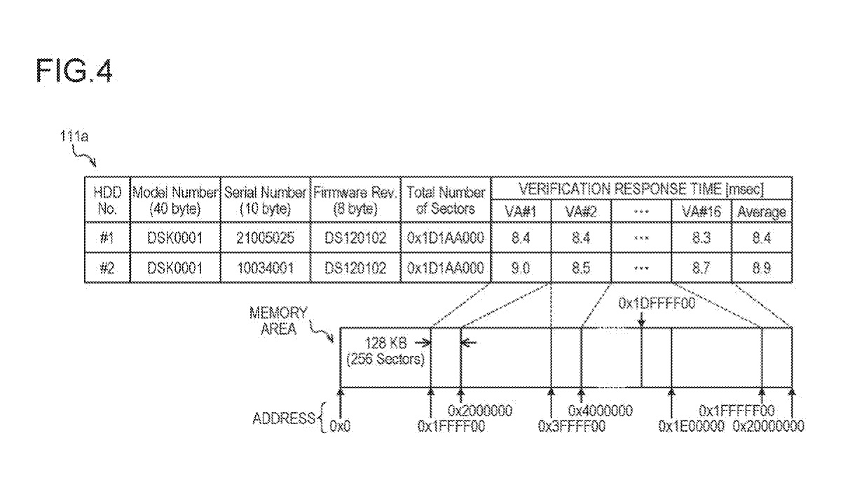

Now, the management table 111a will be further described with reference to FIG. 4. FIG. 4 is a diagram illustrating an example of the management table according to the second embodiment.

As illustrated in FIG. 4, HDD identification information (HDD No.), a model number, a serial number, a firmware revision, and a total number of sectors are stored in the management table 111a. In addition, a response time (verification response time) of a read access, which is measured in the verification process, is stored in the management table 111a. For example, by measuring a response time for a Read Verify Sectors command for the HDD with SATA connection, the verification response time is acquired.

The verification response time is measured for a specific sector section (a range of a predetermined number of successive sectors) among the storage area of the HDD. The example illustrated in FIG. 4 represents a case in which the number of sector sections (the number of samples), for which the verification response time is measured, is set to 16 in the HDD in which a maximum logical block addressing (LBA) is 0x20000000 sectors. In this example, sector sections beginning at 0x2000000-0x100, 0x4000000-0x100, . . . , and 0x20000000-0x100 are set as the specific sector sections. The width of each sector section is set to 256 sectors and 128 KB.

In the example illustrated in FIG. 4, the sector sections are represented by VA#1, VA#2, . . . , and VA#16 in this order from the head of the storage area. An average value of the verification response times along with the verification response times measured for VA#1, VA#2, . . . , and VA#16 is stored in the management table 111a. The verification response times are measured when an HDD is newly added. Accordingly, the verification response times stored in the management table 111a serve as a reference for the response time for a read access to each sector in a non-degraded state.

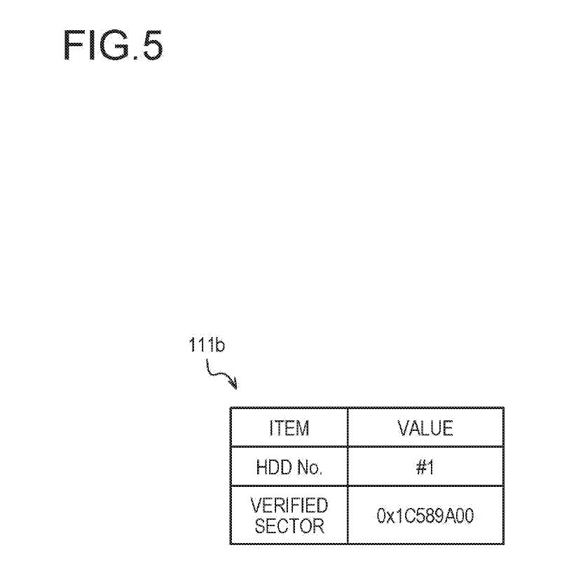

The state information 111b will be further described below with reference to FIG. 5. FIG. 5 is a diagram illustrating an example of the state information according to the second embodiment. As illustrated in FIG. 5, the state information 111b includes HDD identification information (HDD No.) to be subjected to the verification process and an address of a sector (verified sector) subjected to the verification process. It is possible to grasp the progress state of the verification process with reference to the state information 111b.

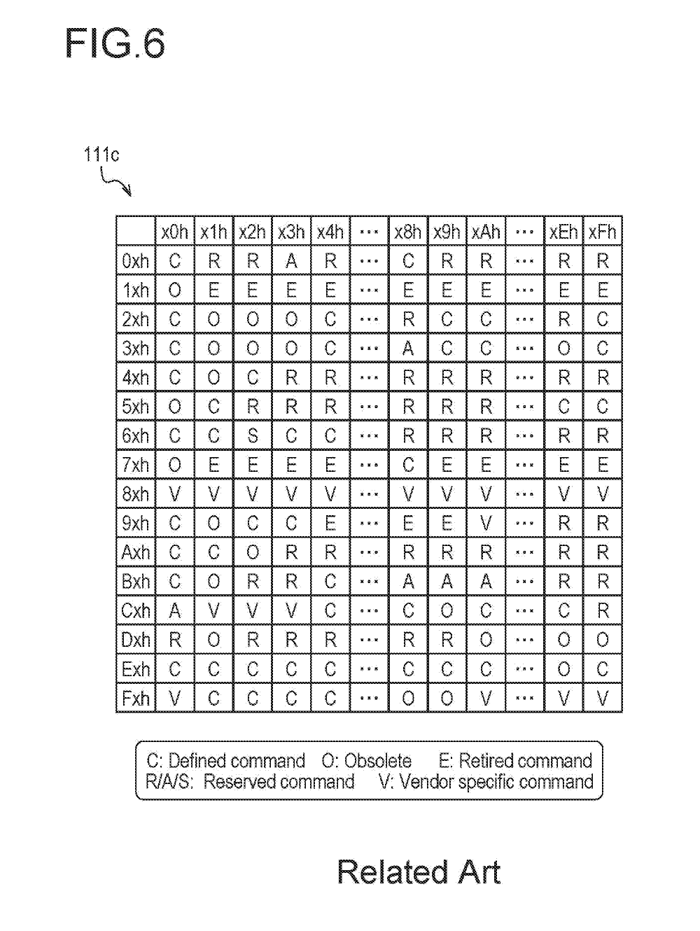

The command information 111c will be further described below with reference to FIG. 6. FIG. 6 is a diagram illustrating an example of the command information. As illustrated in FIG. 6, the command information 111c is a code table indicating a correspondence between identification codes (x0h, . . . , xFh, 0xh, . . . , Fxh) assigned to commands and signs (C, O, E, R, A, S, V) indicating types of the commands. For example, the sign C indicates a general command which is defined in the ATA standard or the like. The sign V indicates a specific command which is specifically defined by a vendor. It is possible to identify a type of a command with reference to the command information 111c.

When a newly added HDD is detected at the time of start-up of the RAID controller 104, the management table preparation unit 112 acquires and stores information of the added HDD in the management table 111a. The management table preparation unit 112 performs the verification process on the added HDD and measures the verification response times for the specific sector sections. Then, the management table preparation unit 112 calculates the average of the verification response times and stores the average value along with the verification response times of the sector sections in the management table 111a.

The command processing unit 113 performs a process in a state (idle state) in which notification of a command is received from the host device 200. For example, when notification of a read command is received from the host device 200, the command processing unit 113 reads data from the HDDs 105 and 106 and verifies whether the data read from the HDDs 105 and 106 are equivalent with each other. When the data are equivalent with each other, the command processing unit 113 performs a process of responding to the host device 200 using the data.

When a command for performing the verification process on the HDDs 105 and 106 is received from the host device 200, the command processing unit 113 notifies the verification processing unit 114 of start of the verification process.

The verification processing unit 114 performs the verification process (a patrol verification process to be described later) on the HDDs 105 and 106 at a timing at which the start of the verification process is notified from the command processing unit 113 or at a predetermined timing. When a sector of which the written state degrades is detected in the verification process, the verification processing unit 114 restores the written state of the sector of which the degradation is detected. For example, when a sector of which the written state degrades is detected in the HDD 105, the verification processing unit 114 reads data identical to the data of the detected sector from the HDD 106 and writes the read data to the detected sector.

Hitherto, the function of the RAID controller 104 has been described.

A flow of a process which is performed by the RAID controller 104 having the above-described functions will be described below.

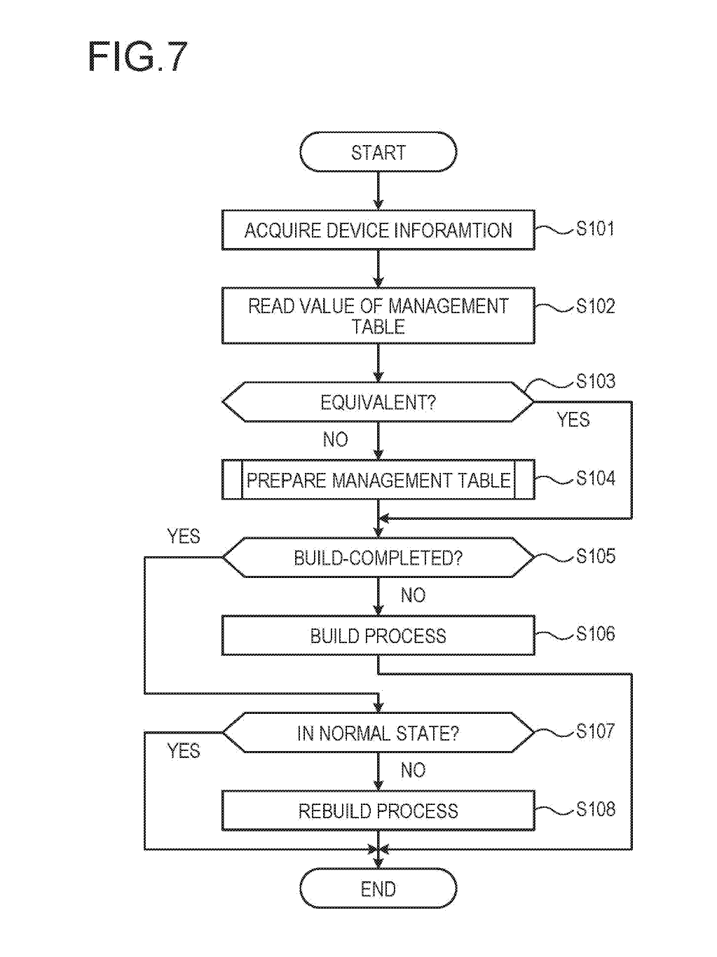

First, a flow of a process which is performed at the time of start-up of the RAID controller 104 will be described with reference to FIG. 7. FIG. 7 is a flowchart illustrating a flow of a start-up process which is performed by the RAID controller according to the second embodiment.

(S101) When the RAID controller 104 is powered on, the management table preparation unit 112 acquires device information (device identification information) from the HDDs coupled with the RAID controller 104.

For example, the management table preparation unit 112 acquires information such as a model number “DSK0001”, a serial number “21005025”, and a firmware revision “DS120102” from the HDD 105 (see FIG. 4). The management table preparation unit 112 acquires a model number “DSK0001”, a serial number “10034001”, and a firmware revision “DS120102” from the HDD 106 (see FIG. 4).

(S102) The management table preparation unit 112 reads the values corresponding to the device information from the management table 111a.

For example, the management table preparation unit 112 reads the model number “DSK0001”, the serial number “21005025”, and the firmware revision “DS120102” corresponding to HDD#1 from the management table 111a (see FIG. 4). The management table preparation unit 112 reads the model number “DSK0001”, the serial number “10034001”, and the firmware revision “DS120102” corresponding to HDD#2 from the management table 111a (see FIG. 4).

(S103) The management table preparation unit 112 determines whether the device information acquired from the HDDs in S101 is equivalent with the values read from the management table 111a in S102. When it is determined that the device information is equivalent with the read value, the process flow proceeds to S105. When it is determined that the device information is not equivalent with the read information, the process flow proceeds to S104.

For example, the device information read from the HDD 105 is equivalent with the value of the management table 111a corresponding to HDD#1. The device information read from the HDD 106 is equivalent with the value of the management table 111a corresponding to HDD#2. In this case, the process flow proceeds to S105. When HDD#3 different from HDD#1 and HDD#2 is coupled with the RAID controller 104, information of HDD#3 is not stored in the management table 111a and thus the device information acquired from HDD#3 in S101 is not equivalent with the value of the management table 111a. In this case, the process flow proceeds to S104.

(S104) For the HDD, of which the device information is not stored in the management table 111a, the management table preparation unit 112 adds device information acquired from the HDD in S101 to the management table 111a. The management table preparation unit 112 performs the verification process for the specific sector sections on the HDD and measures verification response times. The management table preparation unit 112 stores the average value of the verification response times (average response time) along with the measured verification response times in the management table 111a.

As described later, the average response time is used to check the length of a verification response time measured in operation. When the verification response time measured in operation for a section is greater than a threshold value, for example, five times of the average response time, the written state of the relevant sector is restored. The management table preparation unit 112 may store the threshold value calculated from the average response time in the management table 111a.

A time which is calculated by an expression of “average response time+predetermined number of retries×time required for one turn of platter” may be used as the threshold value. For example, when the average response time is 9 ms, the number of retries is 5, and the time required for one turn of the platter is 11 ms (5,400 rpm HDD), the threshold value is 64 ms.

For example, as illustrated in FIG. 4, the management table preparation unit 112 designates an address prior by 256 sectors to the tail of the sections obtained by dividing the storage area into 16 sections, issues Read Verify Sectors (RVS) commands, and measures response times for the RVS commands. Then, the management table preparation unit 112 stores the measured response times as the verification response times in the management table 111a. In addition, the management table preparation unit 112 calculates an average value of the measured verification response times and stores the calculated average value (average response time) in the management table 111a.

(S105) The management table preparation unit 112 determines whether each HDD is in a build-completed state. The build-completed state means a state in which the identical data to that in another HDD is already copied. For example, when the data of the HDD 105 is already copied to the HDD 106, the HDD 106 is in a build-completed state. When HDD#3 is newly added, the data of the HDD 105 is not yet copied to the HDD#3 and thus HDD#3 is not in the build-completed state. When a target HDD is in the build-completed state, the process flow for the target HDD proceeds to S107. When the target HDD is not in the build-completed state, the process flow for the target HDD proceeds to S106.

(S106) The management table preparation unit 112 performs a build process on the HDD which is not in the build-completed state. The build process is a process of copying data stored in an HDD in the build-completed state to an HDD not in the build-completed state and making data to be redundant between the HDDs. For example, when there is HDD#3 not in the build-completed state, the management table preparation unit 112 reads data from the HDD 105 in the build-completed state and copies the read data to HDD#3. When the copying of data is completed, the process flow illustrated in FIG. 7 ends.

(S107) The management table preparation unit 112 determines whether the HDD in the build-completed state is in a normal state. For example, the management table preparation unit 112 issues an RVS command to all sectors of the target HDD and verifies that an error such as a read error or a response delay does not occur. The process flow illustrated in FIG. 7 ends for the normal HDD in which an error does not occur. The process flow for an abnormal HDD, in which an error occurs, proceeds to S108.

(S108) The management table preparation unit 112 performs a rebuild process on the abnormal HDD. The rebuild process is a process of reading data from a normal HDD and copying the read data to the abnormal HDD. At this time, data of the entire area is read from the normal HDD and is written to the abnormal HDD. When the process of S108 is completed, the process flow illustrated in FIG. 7 ends.

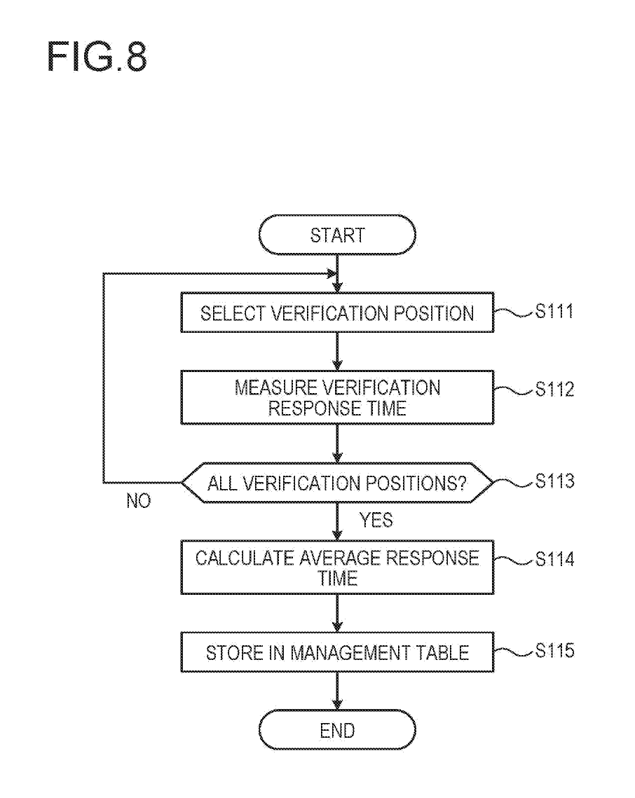

Now, the management table preparation process (S104) will be further described with reference to FIG. 8. FIG. 8 is a flowchart illustrating a flow of the management table preparation process which is performed by the RAID controller according to the second embodiment.

(S111) The management table preparation unit 112 selects a section (verification position) on which a verification process is performed among preset sector sections. For example, when the sector sections VA#1, VA#2, . . . , and VA#16 illustrated in FIG. 4 are set, the management table preparation unit 112 selects the verification position sequentially from the sector section close to the head of the storage area.

(S112) The management table preparation unit 112 measures the verification response time for the sector section selected as the verification position in S111.

For example, when the sector section VA#2 is selected in S111, the management table preparation unit 112 designates the head address 0x3FFFF00 of the sector section VA#2, issues an RVS command, and stores the issuance time. Then, the management table preparation unit 112 calculates the verification response time from a difference between the time at which a response to the RVS command is received from the HDD and the stored issuance time.

(S113) The management table preparation unit 112 determines whether all the verification positions are selected. When all the preset sector sections are selected, the process flow proceeds to S114. When a not-yet-selected sector section remains, the process flow proceeds to S111.

(S114) The management table preparation unit 112 calculates an average (average response time) of the verification response times corresponding to the sector sections measured in S112.

(S115) The management table preparation unit 112 stores the verification response times corresponding to the sector sections and the average response time calculated in S114 in the management table 111a along with the model number, the serial number, the firmware revision, and the total number of sectors of the target HDD. When the process of S115 is completed, the process flow illustrated in FIG. 8 ends.

Hitherto, the process flow which is performed at the time of start-up of the RAID controller 104 has been described. In the above description, the verification response time for each sector section is measured one time, but the verification response time for each sector section may be measured multiple times and an average value thereof may be used as the verification response time for each sector section. The size of the sector sections may be changed in a range meeting the specifications of the SATA standard or the like.

The timing at which the verification response times of the newly added HDD are measured and the measured verification response times are added to the management table 111a may be set after the build process of the corresponding HDD is completed. In this case, the management table preparation unit 112 measures a response time for an access to a magnetic surface, not to a cache of the HDD. The HDD having received the RVS command accesses the magnetic surface and responds thereto. Accordingly, as long as the RVS command is used, the verification response times may be measured after the build process is performed.

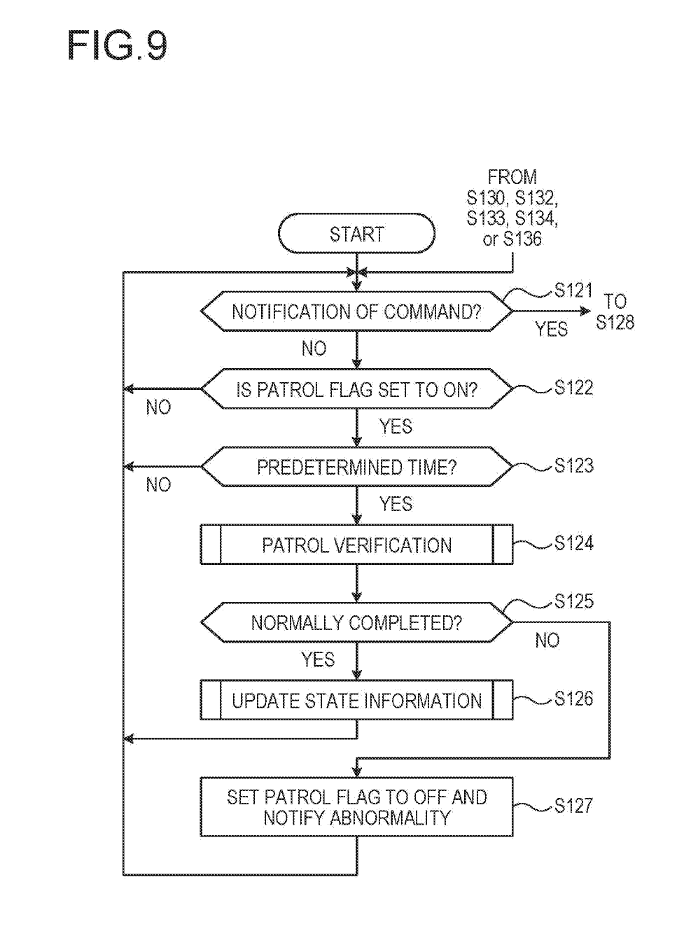

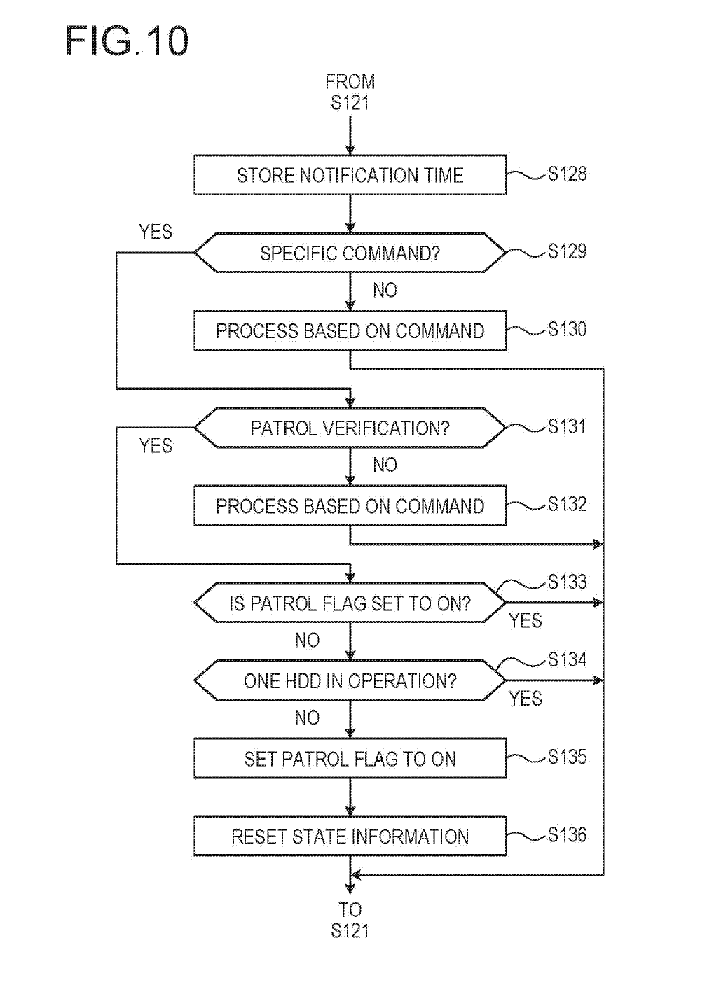

A process flow which is performed by the RAID controller 104 in an idle state will be described below with reference to FIGS. 9 and 10.

FIG. 9 is a first flowchart illustrating a flow of an idle process which is performed by the RAID controller according to the second embodiment. FIG. 10 is a second flowchart illustrating a flow of the idle process which is performed by the RAID controller according to the second embodiment.

(S121) The command processing unit 113 determines whether a command is notified from the host device 200. When it is determined that a command is notified from the host device 200, the process flow proceeds to S128 in FIG. 10. When it is determined that a command is not notified from the host device 200, the process flow proceeds to S122.

(S122) The command processing unit 113 determines whether a patrol flag is set to ON. The patrol flag is a flag for checking the entire storage area of an HDD and determining whether to perform a process (patrol verification) for restoring an error position. The initial value of the patrol flag is ON. When it is determined that the patrol flag is set to ON, the process flow proceeds to S123. When it is determined that the patrol flag is set to OFF, the process flow proceeds to S121.

(S123) The command processing unit 113 determines whether a predetermined time (for example, 100 ms) elapses from the time (notification time) at which the command is notified from the host device 200. When it is determined that the predetermined time elapses from the notification time, the process flow proceeds to S124. When it is determined that the predetermined time does not elapse from the notification time, the process flow proceeds to S121.

(S124) The verification processing unit 114 performs the patrol verification. For example, the verification processing unit 114 recognizes a verified verification position (HDD and sector) with reference to the state information 111b. The verification processing unit 114 determines a verification position (HDD and sector) to be verified subsequent to the recognized verification position. Then, the verification processing unit 114 issues an RVS command for the determined verification position and performs the verification process.

(S125) The verification processing unit 114 determines whether the patrol verification process of S124 is normally completed. When it is determined that the patrol verification process is normally completed, the process flow proceeds to S126. When it is determined that the patrol verification process is abnormally completed, the process flow proceeds to S127.

(S126) The verification processing unit 114 updates the state information 111b using information of the HDD and the sector subjected to the patrol verification process. When the process of S126 is completed, the process flow proceeds to S121.

(S127) The verification processing unit 114 sets the patrol flag to OFF and notifies the host device 200 of abnormality. When it is determined that the patrol verification process is abnormally completed, the patrol flag is set to OFF and the target HDD is separated (degraded) from the RAID group. When the process of S127 is completed, the process flow proceeds to S121.

(S128) The command processing unit 113 stores the notification time in the memory unit 111.

(S129) The command processing unit 113 compares a code added to the command received from the host device 200 with the code table of the command information 111c (see FIG. 6) and determines whether the received command is a specific command (a command corresponding to the sign V). When it is determined that the command received from the host device 200 is a specific command, the process flow proceeds to S131. When it is determined that the command received from the host device 200 is not a specific command, the process flow proceeds to S130.

(S130) The command processing unit 113 performs a process based on the command received from the host device 200.

For example, when a CHECK POWER MODE command is received, the command processing unit 113 checks the power mode (e.g., an idle mode or a sleep mode) of the HDD. In addition, the command processing unit 113 performs a process based on a general command, such as a CONFIGURE STREAM command or a DATA SET MANAGEMENT command, defined in the ATA standard or the like. When the process of S130 is completed, the process flow proceeds to S121 in FIG. 9.

(S131) The command processing unit 113 determines whether the command received from the host device 200 is an instruction to start the patrol verification process. When it is determined that the command is an instruction to start the patrol verification process, the process flow proceeds to S133. At this time, the command processing unit 113 notifies the verification processing unit 114 of the instruction to start the patrol verification process. When it is determined that the command is not an instruction to start the patrol verification process, the process flow proceeds to S132.

Here, a method of defining the instruction to start the patrol verification process in the specific command and notifying the instruction is employed, but, for example, a method of transmitting the start instruction as data of a DOWNLOAD MICROCODE command may well be employed.

(S132) The command processing unit 113 performs a process based on the command. Examples of the specific command include a command for instructing to suspend or stop the patrol verification process and a command for instructing to forcibly perform the rebuild process. When the process of S132 is completed, the process flow proceeds to S121 in FIG. 9.

(S133) The verification processing unit 114 determines whether the patrol flag is set to ON. When it is determined that the patrol flag is set to ON, the process flow proceeds to S121 in FIG. 9. When it is determined that the patrol flag is set to OFF, the process flow proceeds to S134.

(S134) The verification processing unit 114 determines whether the number of HDDs in operation (normal HDDs included in the RAID group) is one. For example, a degraded HDD is not included in the HDDs in operation. When it is determined that the number of the HDDs in operation is one, the process flow proceeds to S121 in FIG. 9. When it is determined that the number of the HDDs in operation is two or more, the process flow proceeds to S135.

(S135) The verification processing unit 114 sets the patrol flag to ON.

(S136) The verification processing unit 114 resets the state information 111b. That is, the verification processing unit 114 updates the HDD identification information (HDD No.) included in the state information 111b to identification information of a next HDD and sets the value of the verified sector to 0. When the process of S136 is completed, the process flow proceeds to S121 in FIG. 9.

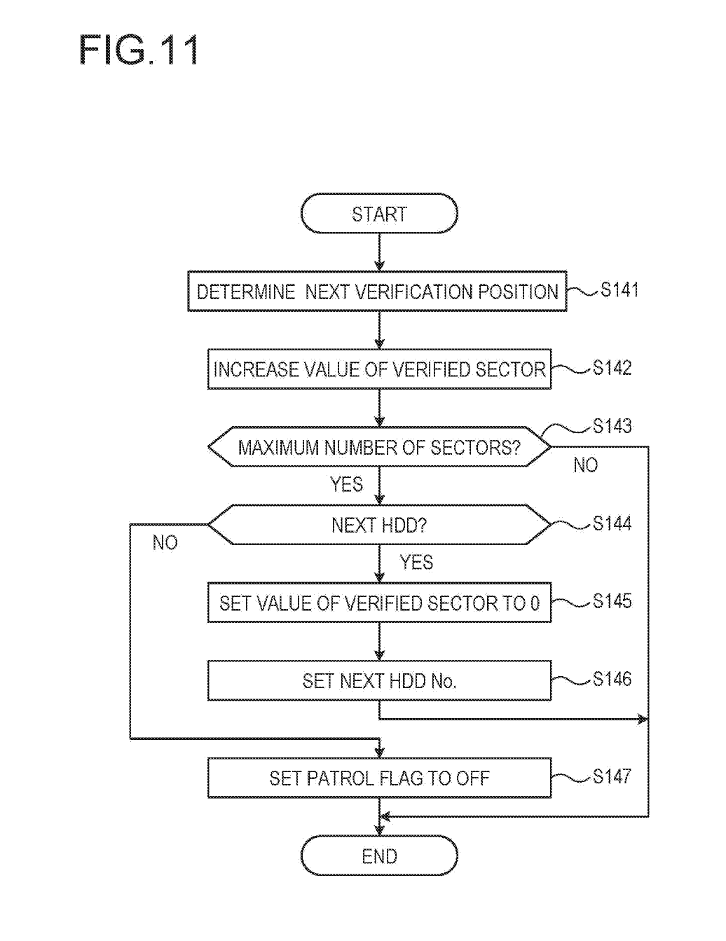

Now the state information update process (S126) will be further described with reference to FIG. 11. FIG. 11 is a flowchart illustrating a flow of the state information update process which is performed by the RAID controller according to the second embodiment.

(S141) The verification processing unit 114 determines an HDD (relevant HDD) and a sector (relevant sector) as a next verification position with reference to the state information 111b.

(S142) The verification processing unit 114 increases the value of the verified sector included in the state information 111b by 256 sectors. The number of sectors increased is equivalent with a length (256 sectors/128 KB in the example illustrated in FIG. 4 or the like) of a section to be processed in the verification process based on the RVS command.

(S143) The verification processing unit 114 determines whether the value of verified sector reaches the maximum number of sectors of the relevant HDD. When it is determined that the value of verified sectors does not reach the maximum number of sectors, the process flow illustrated in FIG. 11 ends. When it is determined that the value of verified sector reaches the maximum number of sectors, the process flow proceeds to S144.

(S144) The verification processing unit 114 determines whether a next HDD to be subjected to the verification process remains. When it is determined that all the HDDs are subjected to the verification process and no next HDD remains, the process flow proceeds to S147. When it is determined that a next HDD remains, the process flow proceeds to S145.

(S145) The verification processing unit 114 sets the value of the verified sector included in the state information 111b to 0.

(S146) The verification processing unit 114 sets the HDD identification information (HDD No.) included in the state information 111b to identification information of a next HDD. When the process of S146 is completed, the process flow illustrated in FIG. 11 ends.

(S147) The verification processing unit 114 sets the patrol flag to OFF. When the process of S147 is completed, the process flow illustrated in FIG. 11 ends.

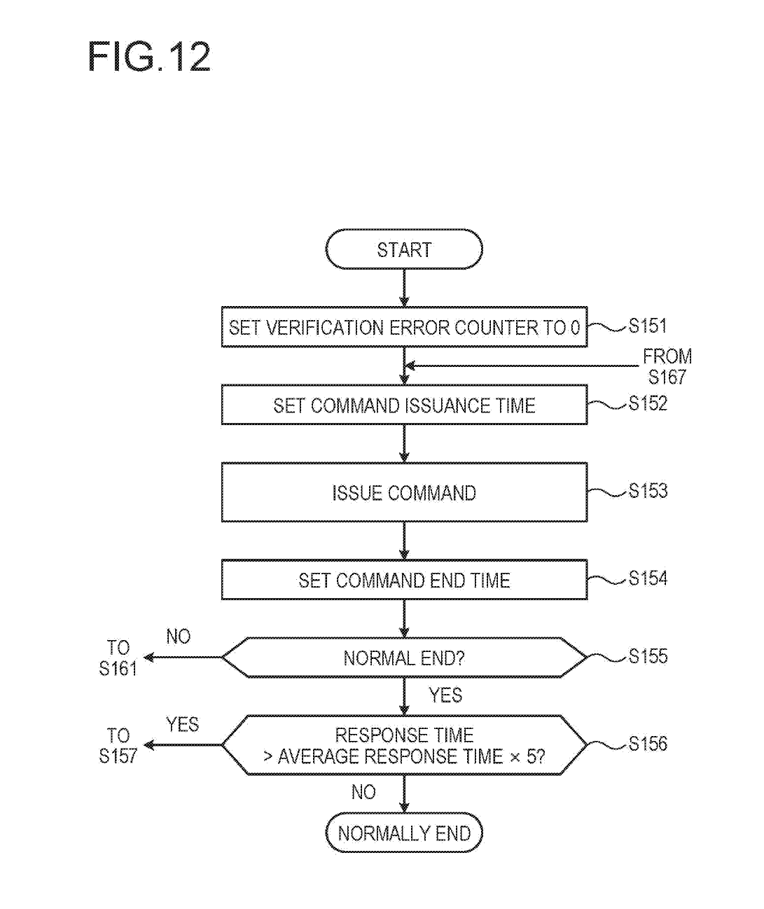

Now, a flow of the patrol verification process (S124) will be further described with reference to FIGS. 12 to 14.

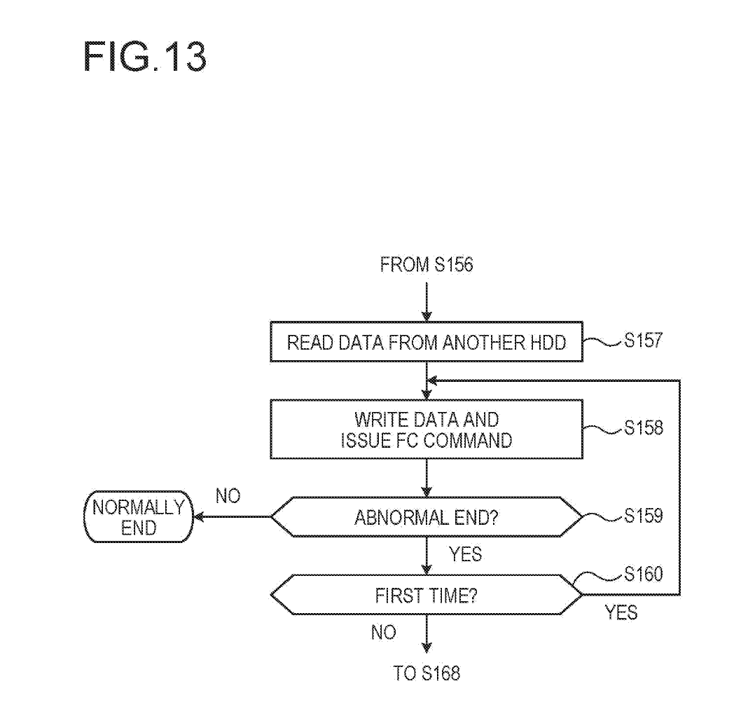

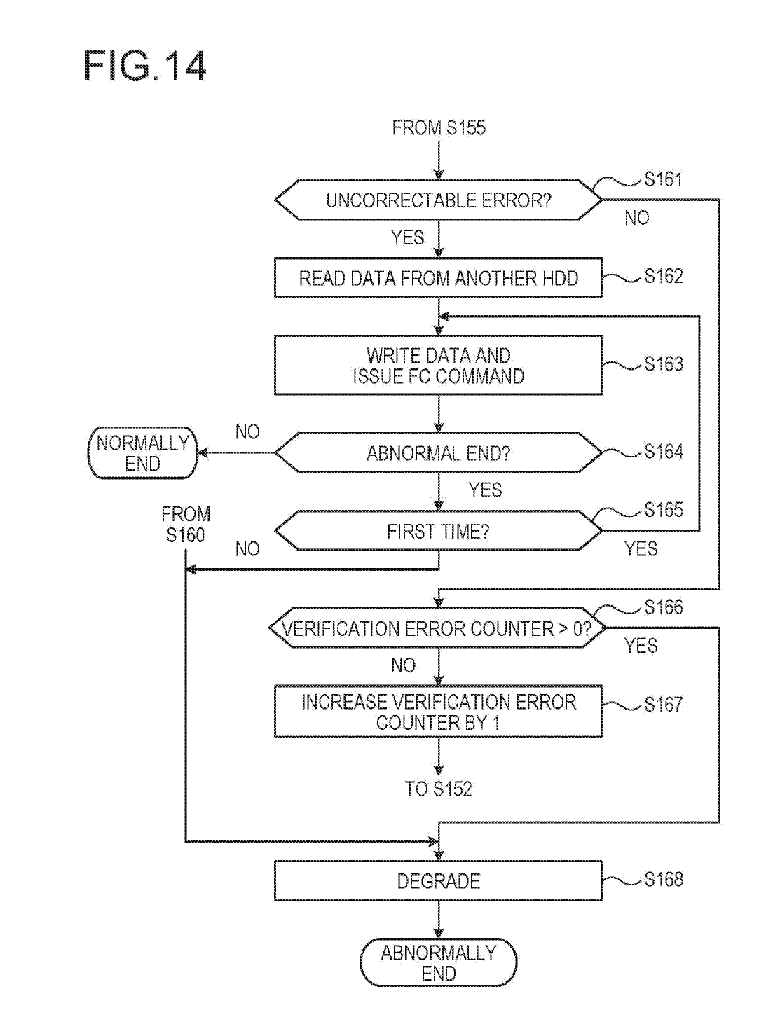

FIG. 12 is a first flowchart illustrating a flow of the patrol verification process which is performed by the RAID controller according to the second embodiment. FIG. 13 is a second flowchart illustrating the flow of the patrol verification process which is performed by the RAID controller according to the second embodiment. FIG. 14 is a third flowchart illustrating the flow of the patrol verification process which is performed by the RAID controller according to the second embodiment.

(S151) The verification processing unit 114 sets (initializes) a verification error counter to 0. The verification error counter is a parameter indicating the number of times at which a correctable error occurs in the verification process. For example, when data is normally read from a target sector of the RVS command but the process based on the RVS command abnormally ends, the verification error counter is counted up.

(S152) The verification processing unit 114 sets the current time as a command issuance time. The current time represents an elapsed time from the power-on of the RAID controller 104 to the present. The verification processing unit 114 stores the set value of the command issuance time in the memory unit 111.

(S153) The verification processing unit 114 issues an RVS command to a target HDD and receives a response to the RVS command from the target HDD. At this time, the verification processing unit 114 determines an HDD and a sector to be processed based on the RVS command from the HDD identification information and the value of the verified sector included in the state information 111b. Then, the verification processing unit 114 designates the determined target HDD and the determined sector to issue the RVS command.

(S154) The verification processing unit 114 sets the current time as a command end time. That is, the verification processing unit 114 sets the time at which the response to the RVS command is received as the command end time. The verification processing unit 114 stores the set value of the command end time in the memory unit 111.

(S155) The verification processing unit 114 determines whether the process based on the RVS command normally ends. When it is determined that the process based on the RVS command normally ends, the process flow proceeds to S156. When it is determined that the process based on the RVS command abnormally ends, the process flow proceeds to S161 in FIG. 14.

(S156) The verification processing unit 114 calculates “command end time−command issuance time” which is a time (verification response time) required for performing the process based on the RVS command. Then, the verification processing unit 114 reads the average response time for the target HDD from the management table 111a and determines whether the calculated verification response time is greater than five times the average response time.

When it is determined that the verification response time is greater than five times the average response time, the process flow proceeds to S157 in FIG. 13. When it is determined that the verification response time is not greater than five times the average response time, the process flows illustrated in FIGS. 12 to 14 normally end.

The determination process of S156 is a process of determining whether the verification response time in operation exceeds an allowable range in comparison with the average verification response time (average response time) of the target HDD in the normal state. In the above-described example, five times the average response time is used as a reference (threshold value), but two times, ten times, or the like other than five times the average response time may be used as the reference.

Alternatively, a time which is calculated by an expression “average response time+predetermined number of retries×time required for one turn of platter” may be used as the threshold value. For example, when the average response time is 9 ms, the number of retries is 5, and the time required for one turn of the platter is 11 ms (5,400 rpm HDD), the threshold value is 64 ms.

(S157) The verification processing unit 114 reads data of the relevant sector from an HDD (another HDD) other than the target HDD. That is, the verification processing unit 114 acquires the data identical to the data of the relevant sector in which the verification response time is greater than a threshold based on the average response time and which has a possibility that the written state degrades, from another HDD which normally operates. For example, the verification processing unit 114 issues a READ DMA (Direct Memory Access) command to read data corresponding to 256 sectors from another HDD.

(S158) The verification processing unit 114 writes the data read from another HDD in S157 to the relevant sector. For example, the verification processing unit 114 designates the relevant sector to issue a WRITE DMA command to the target HDD. The verification processing unit 114 also issues a FLUSH CACHE (FC) command. The FC command is a command for writing data stored in a write cache to a magnetic surface.

(S159) The verification processing unit 114 determines whether the FC command abnormally ends. That is, the verification processing unit 114 determines whether data is normally written to the relevant sector of the target HDD or abnormality occurs in the writing. When it is determined that the FC command abnormally ends, the process flow proceeds to S160. When it is determined that the FC command normally ends, the process flows illustrated in FIGS. 12 to 14 normally end.

When it is determined that the FC command normally ends, the verification processing unit 114 may perform a verification process on the relevant sector again to check a written state thereof. In this case, the verification processing unit 114 issues the RVS command to the relevant sector and causes the process flow to proceed to S160 when the measured verification response time is greater than five times the average response time. When the measured verification response time is not greater than five times the average response time, the process flows illustrated in FIGS. 12 to 14 normally end. In this way, the re-checking may be performed and it may be possible to enhance reliability by the re-checking.

(S160) The verification processing unit 114 determines whether the FC command for the relevant sector abnormally ends at the first time. When it is determined that the abnormal end is the first time, the process flow proceeds to S158. When it is determined that the abnormal end is not the first time, the process flow proceeds to S168 in FIG. 14.

Here, a method of re-attempting to write data to the relevant sector when the abnormal end of the FC command is the first time, but the number of the retries may be set to two or more. However, when the FC command abnormally ends, there is a possibility that the HDD malfunctions. Accordingly, it is realistic that rewriting is not attempted when the FC command abnormally ends or only one time of rewriting is performed as in this example.

(S161) The verification processing unit 114 determines whether the abnormal end of the RVS command is due to an uncorrectable error in which data is not normally read from the relevant sector. When it is determined that the abnormal end is due to an uncorrectable error, the process flow proceeds to S162. When it is determined that the abnormal end is not due to an uncorrectable error, the process flow proceeds to S166.

(S162) The verification processing unit 114 reads the data of the relevant sector from an HDD (another HDD) other than the target HDD. For example, the verification processing unit 114 issues a READ DMA command to read data corresponding to 256 sectors from another HDD.

(S163) The verification processing unit 114 writes the data read from another HDD in S162 to the relevant sector. For example, the verification processing unit 114 designates the relevant sector of the target HDD to issue a WRITE DMA command. The verification processing unit 114 also issues a FLUSH CACHE (FC) command.

(S164) The verification processing unit 114 determines whether the FC command abnormally ends. That is, the verification processing unit 114 determines whether data is normally written to the relevant sector of the target HDD or abnormality occurs in the writing. When it is determined that the FC command abnormally ends, the process flow proceeds to S165. When it is determined that the FC command normally ends, the process flows illustrated in FIGS. 12 to 14 normally end.

When it is determined that the FC command normally ends, the verification processing unit 114 may perform a verification process on the relevant sector again to check a written state thereof. In this case, the verification processing unit 114 issues the RVS command to the relevant sector and causes the process flow to proceed to S165 when the measured verification response time is greater than five times the average response time. When the measured verification response time is not greater than five times the average response time, the process flows illustrated in FIGS. 12 to 14 normally end. In this way, the re-checking may be performed and it may be possible to enhance reliability by the re-checking.

(S165) The verification processing unit 114 determines whether the FC command for the relevant sector abnormally ends at the first time. When it is determined that the abnormal end is the first time, the process flow proceeds to S163. When it is determined that the abnormal end is not the first time, the process flow proceeds to S168.

Here, a method of re-attempting to write data to the relevant sector when the abnormal end of the FC command is the first time, but the number of the retries may be set to two or more. However, when the FC command abnormally ends, there is a possibility that the HDD malfunctions. Accordingly, it is realistic that rewriting is not attempted when the FC command abnormally ends or only one time of rewriting is performed as in this example.

(S166) The verification processing unit 114 determines whether the verification error counter is greater than 0. That is, the verification processing unit 114 determines whether an error other than an uncorrectable error is already detected in the relevant sector. When it is determined that the verification error counter is greater than 0, the process flow proceeds to S168. When it is determined that the verification error counter is not greater than 0, the process flow proceeds to S167.

(S167) The verification processing unit 114 increases the verification error counter by 1. When the process of S167 is completed, the process flow proceeds to S152 in FIG. 12.

(S168) The verification processing unit 114 separates (degrades) the target HDD from the RAID. That is, when the process flow proceeds to S168, it may be determined that an uncorrectable error occurs in the target HDD. Accordingly, the verification processing unit 114 excludes the target HDD from the RAID group. When the process of S168 is completed, the process flows illustrated in FIGS. 12 to 14 abnormally end.

Hitherto, the process flow which is performed by the RAID controller 104 has been described.

While the storage apparatus 100 equipped with the two HDDs 105 and 106 has been exemplified, the above-described technique according to the second embodiment may be applied to a case in which the number of HDDs is three or more. When the number of HDDs is three or more, it is possible to further enhance reliability by applying the majority logic at the time of reading data.

The majority logic is a method of reading and comparing data from relevant sectors of HDDs having identical data written thereto and responding using the most data that are equivalent with each other. For example, in a storage apparatus including three HDDs HDD#1, HDD#2, and HDD#3 which are mirrored, when a request for reading data from sector 001 is issued, the data read from HDD#1, HDD#2, and HDD#3 are compared with each other. When the data of HDD#1 and HDD#2 is equivalent with each other and is not equivalent with the data of HDD#3, the equivalent data of HDD#1 and HDD#2 is returned to the host device.

As described above, it is possible to enhance the reliability by checking whether the data read from the HDDs are equivalent with each other, but when an HDD delaying a response is present, the response to the host device is delayed. The HDD causing the response delay may be restored by separating the HDD from the RAID and performing a rebuild process therefor, but the reliability decreases during the rebuild process. Even when a response delay does not occur to an extent requiring the rebuild process, a delay of the response to the host device occurs.

However, when the above-described technique according to the second embodiment is applied, the sector having a long verification response time is restored at the timing of performing the patrol verification process and thus the written states of the HDDs are kept in an excellent condition. As a result, an excellent performance is maintained in the entire RAID, and the storage apparatus may return a response to a read access in a stably suitable response time. When the number of HDDs increases, a risk that the written state of at least one HDD will degrade also increases and thus the effects of the above-described technique according to the second embodiment are also improved.

Further, since data is re-written to the relevant sector before an error occurs in the HDD, it is possible to improve performance of a read access in comparison with a case to which the above-described technique according to the second embodiment is not applied. In addition, since the frequency of the rebuild process of copying data to the entire area of the HDD may be reduced, it is possible to reduce an operation time in a state with reduced reliability due to reduction of the redundancy, thus enhancing the reliability of a business operation.

Hitherto, the second embodiment has been described.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage apparatus, comprising:
a first storage device configured to store therein data;
a second storage device different from the first storage device, the second storage device being configured to store therein data identical to the data stored in the first storage device;
a memory device configured to store therein a first threshold value which is set on basis of response times for accessing first plural sections of the first storage device; and
a processor configured to
measure a first response time for reading data from the respective first plural sections,
read first data from the second storage device when a first target section of the first plural sections is detected, the first response time for reading data from the first target section being greater than the first threshold value, the first data being identical to data stored in the first target section, and
write the first data to the first target section.

2. The storage apparatus according to claim 1, wherein
the processor is configured to
measure, upon writing the first data to the first target section, a second response time for reading data from the first target section, and
avoid an access to the first storage device when the second response time is greater than the first threshold value.

3. The storage apparatus according to claim 1, wherein
the memory device is configured to store therein a second threshold value which is set on basis of response times for accessing second plural sections of the second storage device, and
the processor is configured to
measure a second response time for reading data from the respective second plural sections,
read second data from the first storage device when a second target section of the second plural sections is detected, the second response time for reading data from the second target section being greater than the second threshold value, the second data being identical to data stored in the second target section, and
write the second data to the second target section.

4. A control device, comprising:
a memory device configured to store therein a first threshold value which is set on basis of response times for accessing first plural sections of a first storage device configured to store therein data; and
a processor configured to
measure a first response time for reading data from the respective first plural sections,
read first data from a second storage device different from the first storage device when a first target section of the first plural sections is detected, the first response time for reading data from the first target section being greater than the first threshold value, the first data being identical to data stored in the first target section, and
write the first data to the first target section.

5. A non-transitory computer-readable recording medium having stored therein a program that causes a computer to execute a process, the process comprising:
acquiring a first threshold value from a memory device, the first threshold value being set on basis of response times for accessing first plural sections of a first storage device configured to store therein data;
measuring a first response time for reading data from the respective first plural sections;
reading first data from a second storage device different from the first storage device when a first target section of the first plural sections is detected, the first response time for reading data from the first target section being greater than the first threshold value, the first data being identical to data stored in the first target section; and
writing the first data to the first target section.
